(19) United States
(12) Patent Application Publication
(10) Pub. No.: US 2007/0199904 A1
(43) Pub. Date: Aug. 30, 2007

(54) Methods for treatment of organic matter in liquid

(76) Inventor: Jonathan Thompson, Center City, MN (US)

Correspondence Address: Mark J. Burns;Haugen Law Firm PLLP, Suite 1130, 121 South Eighth Street, Minneapolis, MN, 55402, US

(21) Appl. No.: 11/363,975

(22) Filed: Feb. 27, 2006

(51) Int. Cl. C02F 1/32

(52) U.S. Cl. 210/748

(57) ABSTRACT

A method for treating organic matter in a liquid includes transporting the liquid through a gas-permeable, liquid-impermeable conveyance member and exposing the liquid to an organic matter treatment agent while the liquid is disposed in the conveyance member. The method further includes removing one or more product gases from the liquid through a wall of the conveyance member, with the one or more product gases being disposed in the liquid as a consequence of the treatment of the organic matter by the treatment agent.

### FIELD OF THE INVENTION

The present invention relates to methods for detecting organic matter in and purifying liquids, and more particularly to methods for reducing and/or eliminating organic matter in liquids such as water. The invention further relates to systems for effecting and monitoring the extent of such treatment of organic matter.

### BACKGROUND OF THE INVENTION

Water and other liquid treatment methodologies and systems have been developed and implemented over a wide range of applications. Most typically, such purification efforts are focused on water at either or both of feed streams and waste streams from a variety of processes. In many cases, a high level of purity at the feed side of the process is desired so as to minimize or eliminate process variables or inaccuracies introduced by impurities. Examples of applications that seek or require purified liquids, and particularly purified water, include semi-conductor manufacturing, food and beverage manufacturing, laboratory uses, medical germicidal uses, and analytical chemistry applications. Total organic and inorganic treatment and detection systems purify the liquid and analyze the byproducts.

In applications seeking to remove organic matter from liquid water or water vapor, certain treatment agents are widely recognized as being useful in destroying the organic matter. Such treatment agents include, for example, ultraviolet radiation, hydrogen gas with an oxidizer, ozone gas, chlorine, and other chemical treatment agents. Ultraviolet radiation, for example, treats organic matter in water through two primary methods. For example, certain wavelength radiation within the ultraviolet band excites carbon-carbon bonds to a point wherein the bonds are broken, leaving molecules that are sufficiently volatile to form gas at room temperature. Ultraviolet radiation is further known to break up water molecules into OH radicals. The oxidizing radicals created by the ultraviolet radiation then attack organic matter in the water to create CO₂ and H₂O, with the carbon dioxide forming a gas at room temperature. Ultraviolet radiation wavelengths of 185 nm and 254 nm are known to have the above effects on organic and water molecules. There are many other combinations of treatment agents and other mechanisms for creating and/or introducing oxidizing reagents in water.

The treatment of organic matter in water through the use of ultraviolet radiation and a photo-reactive oxidizer is preferred due to the fact that the reaction tends to have a higher degree of completion, and the products created in such treatment are environmentally friendly. For example, ozonation of organic matter in water produces carbon dioxide and water. In many applications, however, process feed streams are desired to be free of entrained fixed gases or free of inorganic carbon. Such applications include, for example, semi-conductor manufacturing, TOC detection, and liquid chromatography, wherein even small amounts of dissolved gases can interfere with the accuracy and quality of the results obtained. Accordingly, feed streams to such applications must be degassed prior to utilization. Such degassing is particularly germane where organic matter treatment of the feed stream has been conducted through techniques adding or developing gaseous species thereto, as described above.

The semi-conductor manufacturing industry is an example application that has long utilized a plurality of process steps to purify and degas liquid feed streams. Such process steps are conventionally accomplished in distinct apparatus. For example, conventional systems incorporate a first apparatus for treating organic matter in e.g. water, and then involve a second distinct apparatus to degas the feed stream once organic matter treatment has taken place. Typically, feed streams are treated to remove organic matter by being transported in quartz tubing, such that ultraviolet radiation may penetrate into the liquid and subsequently destroy the organic matter. The quartz containers transporting the feed stream through the ultraviolet radiation zone, however, maintain all gaseous reactants and products within the liquid stream, as the quartz is substantially liquid and gas impermeable. The feed stream must therefore be subsequently passed to a separate degassing apparatus for removal of reactant and product gases prior to utilization of the liquid feed stream in the given process.

It is therefore a principal object of the present invention to provide a single liquid treatment apparatus that both treats organic matter in the liquid and removes gases therefrom, so as to provide outlet liquid that is both purified and degassed.

It is a further object of the present invention to provide a method for treating organic matter in a liquid stream flowing through fouling and degradation-resistant polymeric material that is substantially gas-permeable and liquid-impermeable, and transparent to ultraviolet radiation.

It is a still further object of the present invention to provide a treatment chamber for treating organic matter in liquid, which chamber introduces into the liquid one or more organic matter treatment agents, and has an environment conducive to removing gases from the liquid through a gas-permeable, liquid-impermeable polymeric conveyance member.

It is a yet further object of the present invention to provide a vacuum degassing chamber that is resistant to photolysis, and through which treatment liquid is conveyed, and in which one or more organic matter treatment agents are deployed to treat organic matter in the liquid.

### SUMMARY OF THE INVENTION

By means of the present invention, a method for treating organic matter in a liquid stream is provided in a single apparatus. The organic matter treatment is facilitated by the conveyance of the organic matter-containing liquid through a treatment chamber within an inert and fouling-resistant polymeric conveyance member. Such polymeric material is both transparent to ultraviolet radiation and gas-permeable and substantially liquid-impermeable, so as to enable penetration of organic matter treatment agents through a barrier wall of the conveyance member into the liquid stream while acting as an effective vessel for such liquid. In addition, the gas-permeable characteristics of the conveyance member enables the treatment chamber to effect a degassing mechanism on the contained liquid, such that the liquid is both purified and degassed prior to exiting from the treatment chamber. The degassing mechanism is brought about by differentials in partial pressures of respective product gases in the liquid stream, as compared to such partial pressures in the treatment chamber external to the liquid conveyance member. By Henry's Law of Partial Pressure, target gas species may be removed from the liquid stream by maintaining the environment within the treatment chamber and external to the liquid conveyance member at target gas partial pressures lower than such partial pressures in the liquid stream. Such an environment may be accomplished through the utilization of a sweep fluid or of an at least partially evacuated treatment chamber.

A plurality of chambers can be connected together to aid the measurement of entrained gases separate from introducing oxidizing agents to dissolved organic matter in water and subsequently measuring reaction byproducts.

In a particular embodiment, the method for treating organic matter in a liquid includes transporting the organic matter-containing liquid through a conveyance member that is substantially gas-permeable and liquid-impermeable, and introducing to the liquid an organic matter treatment agent while the liquid is disposed in the conveyance member. The method further provides removing one or more product gases from the liquid through a wall of the conveyance member, with the one or more product gases being disposed in the liquid as a consequence of the treatment of the organic matter by the treatment agent.

A further embodiment of the present invention includes providing a treatment chamber having one or more liquid conveyance members passing therethrough, which liquid conveyance members are substantially gas-permeable and liquid-impermeable. The liquid is transported in the liquid conveyance member through the treatment chamber where the liquid is introduced to an organic matter treatment agent. One or more product gases are then removed from the liquid through a wall of the conveyance member, wherein the one or more product gases are disposed in the liquid as a consequence of the treatment of the organic matter by the treatment agent.

An additional embodiment of the invention provides a system for treating organic matter in a liquid, with the system including a chamber having inlet and outlet connections for admitting and discharging the liquid to be treated. A gas-permeable, liquid-impermeable conveyance member conducts the liquid through the chamber between the inlet and outlet connections. The system further includes an organic matter treatment agent dispensing device for introducing the liquid to one or more organic matter treatment agents, such that one or more product gases are developed in the liquid to respective first partial pressures as a result of the treatment of the organic matter by the one or more organic matter treatment agents. The volume within the chamber external to the conveyance member has respective second partial pressures of the one or more product gases that are lower than corresponding first partial pressures of such product gases so as to remove the one or more product gases from the liquid through an outer wall of the conveyance member. The treatment agents may optionally be placed in the conduit member upstream and downstream to facilitate purification or conversion of organic matter into inorganic matter. The agents may also be introduced as a liquid prior to the chamber through a dosing valve.

### BRIEF DESCRIPTION OF THE DRAWINGS

FIG. 1 is a schematic view of an organic matter treatment system of the present invention;

FIG. 2 is a schematic view of an organic matter treatment system of the present invention; and

FIG. 3 is a schematic view of an organic matter treatment system of the present invention.

### DETAILED DESCRIPTION OF THE PREFERRED EMBODIMENTS

The objects and advantages enumerated above together with other objects, features, and advances represented by the present invention will now be presented in terms of detailed embodiments described with reference to the attached drawing figures which are intended to be representative of various possible configurations of the invention. Other embodiments and aspects of the invention are recognized as being within the grasp of those having ordinary skill in the art.

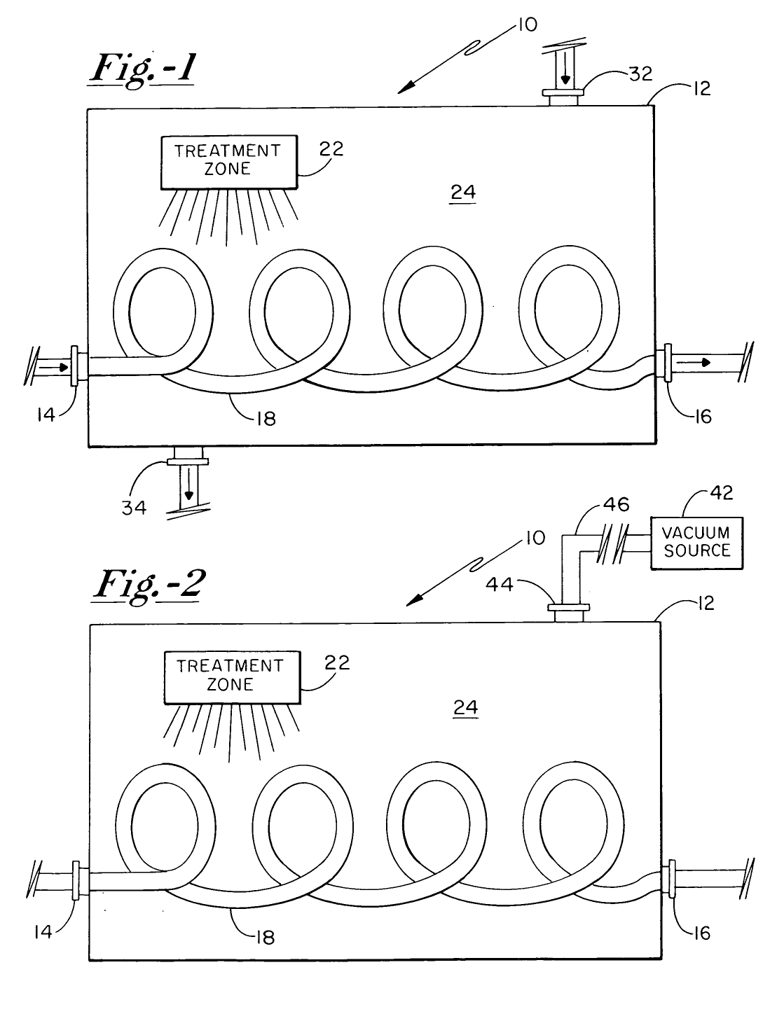

With reference now to the drawing figures, and first to FIG. 1, a treatment system 10 of the present invention includes a treatment chamber 12 having inlet and outlet connections 14, 16 for admitting and discharging liquid to be treated by system 10. A conveyance member, such as a tube 18, preferably conducts liquid through chamber 12 between inlet and outlet connections 14, 16.

Preferably, system 10 further includes an organic matter treatment agent dispensing device 22 for introducing the liquid within conveyance member 18 to one or more organic matter treatment agents. A variety of organic matter treatment agents may be utilized in the systems and methods of the present invention, with the purpose of such agents being to breakdown and/or destroy relatively long-chain organic molecules in the liquid stream. Typically, molecules having at least four carbon atoms are in liquid or solid state at feed or waste stream temperatures, such as ambient room temperature. Such materials, therefore, must be treated in some fashion before being removed from the liquid process stream in a gaseous state.

For the purposes of the present invention, treatment agents which cause the breakdown and/or destruction of organic matter molecules without substantial heating of the liquid process stream is desired. Accordingly, known organic matter treatment agents such as ultraviolet radiation and ozone gas are examples of effective mechanisms by which to treat organic matter. Dispensing device 22, therefore, preferably emits or deploys organic matter treatment agents into the liquid that is conveyed within the confines of chamber 12. Dispensing device 22 may, for example, comprise one or more ultraviolet radiation lamps and/or ozone gas vents that are directed toward conveyance member 18. The ozone gas may either be generated at dispensing device 22, or at a remote location and subsequently transported to dispensing device 22 for deployment within chamber 12.

In preferred embodiments, dispensing device 22 may be positioned adjacent inlet connection 14, such that treatment of organic matter in the liquid stream begins as soon as the liquid has entered chamber 12 within conveyance member 18. In doing so, the organic matter treatment agents deployed by dispensing device 22 operably act upon the organic matter at the early stages of the liquid passage through chamber 12. In some embodiments, additional organic matter treatment agents may be added to the liquid stream at locations upstream from inlet connection 14 of chamber 12 so as to enhance the effectiveness of the organic matter treatment agents deployed by dispensing device 22. A particular example of such an embodiment is in the addition of ozone gas to the liquid stream prior to chamber 12, with dispensing device 22 comprising ultraviolet radiation lamps, which further activate the ozone gas within the liquid stream in conveyance member 18 to treat organic matter therein.

Preferably, conveyance member 18 is fabricated from a substantially gas-permeable, liquid-impermeable material. An example of such a material is a copolymer of perfluoro-2,2-dimethyl-1,3-dioxole (“PDD”). In some embodiments, the copolymer is a dipolymer of PDD and a complimentary amount of tetrafluoroethylene (“TFE”), which is available from E.I. Du Pont De Nemours and Company of Wilmington, Del. under the trade name Teflon AF®. This material may be formed through extrusion or other processes into various configurations including tubing for conveying liquid therethrough, such as in conveyance member 18 of the present invention. As formed, the PDD-TFE polymeric material constitutes a non-porous membrane that is gas-permeable and liquid-impermeable, and is also resistant to fouling. Moreover, in its base form, such a polymeric material is substantially transparent to ultraviolet radiation or has light guiding properties. As such, ultraviolet light emitted external to conveyance member 18 can interact with the conveyed liquid and/or an organic matter treatment agent within the liquid so as to treat the organic matter. Although Teflon AF® has been described above as being a particularly preferred material for use in constructing conveyance member 18, the use of other gas-permeable, liquid-impermeable materials are contemplated by the present invention. Examples of such alternative materials include expanded FEP and expanded porous PTFE.

As shown in the embodiment illustrated in FIG. 1, organic matter-containing liquid is fed to treatment chamber 12 at inlet connection 14, such that the liquid to be treated preferably flows through conveyance member 18. By means of the physical characteristics of conveyance member 18, the one or more organic matter treatment agents deployed by dispensing device 22 penetrate through a containment wall of conveyance member 18 into the organic matter-containing liquid stream. Once the one or more treatment agents have entered the liquid stream, the organic matter contained in the liquid is caused to be broken down and/or destroyed. Such a process typically involves the production of gaseous and/or liquid species. A gas commonly generated in the treatment of organic matter is carbon dioxide. Such generated gaseous species, as well as unused gaseous treatment agents such as ozone are preferably removed from the liquid stream prior to exiting out from treatment chamber 12 at outlet connection 16. Such gaseous materials are together referred to herein as product gases, with the term product gases further including any latent gaseous species contained in the liquid stream that are not one of the gaseous treatment agents or gaseous products of the treatment of organic matter in the liquid stream.

System 10 of the present invention preferably enables and accomplishes removal of such product gases from the liquid stream transported through chamber 12 by conveyance member 18. System 10 of the present invention utilizes Henry's Law of Partial Pressure to draw gaseous species from a relatively high partial pressure within the liquid stream to a relatively low partial pressure external to conveyance member 18. The difference in respective partial pressures may be referred to as a partial pressure potential. Preferably, such a partial pressure potential is generated for each of the gaseous species disposed in the liquid stream that are desired to be removed prior to exiting out from chamber 12 at outlet connection 16. Partial pressure potential (ΔP) is described by the following relationship:
ΔP=P_{AL}−P_{AZ}
Where P_{AL}=the partial pressure of gaseous species A in the liquid stream; and
   P_{az}=the partial pressure of gaseous pressure of gaseous species A in internal volume zone 24 of chamber 12

In order for gaseous species “A”, for example, to be removed from the liquid stream, the value for ΔP must be positive. In other words, the partial pressure of gaseous species A in the liquid stream must be greater than the partial pressure of gaseous species A in zone 24.

One method to accomplish a partial pressure potential is to pass a “sweep” fluid through internal volume zone 24 within chamber 12 and external to conveyance member 18, which sweep fluid contains lower partial pressures of the respective product gases than the corresponding product gas partial pressures within the liquid stream. In preferred embodiments, the sweep fluid may be nitrogen gas, though any gas or liquid may be utilized as the sweep fluid, so long as it contains the relatively low partial pressures described above.

In the embodiment illustrated in FIG. 1, the sweep fluid is delivered to zone 24 within chamber 12 at sweep fluid inlet 32, and is drawn out from zone 24 at sweep fluid outlet 34. Preferably, sweep fluid inlet 32 and sweep fluid outlet 34 are positioned so as to create a “counter-flow” arrangement, wherein the sweep fluid is passed through chamber 12 in a direction that is substantially opposite to the conveyance direction of the liquid. It has been determined that such a counter-flow arrangement provides an efficient method for removing product gases from the liquid stream. Other arrangements for passing the sweep fluid about conveyance member 18, however, are contemplated by the present invention, and would be predicted and understood by those of ordinary skill in the art given the present description.

A further mode for generating the desired partial pressure potential as described above is shown in the embodiment of FIG. 2, wherein treatment chamber 12 is operably coupled to a vacuum source 42 for operably evacuating zone 24 within chamber 12. In this embodiment, vacuum source 42 may be, for example, a vacuum pump that maintains zone 24 in an at least partially evacuated state. Vacuum source 42 is preferably coupled to treatment chamber 12 at connection 44 via vacuum line 46. The relatively low pressure environment within treatment chamber 12 preferably results in respective partial pressures in zone 24 that are sufficiently lower than the corresponding partial pressures of the gaseous species in the liquid stream to enable a degassing function out through the containment wall of the gas-permeable, liquid-impermeable conveyance member 18.

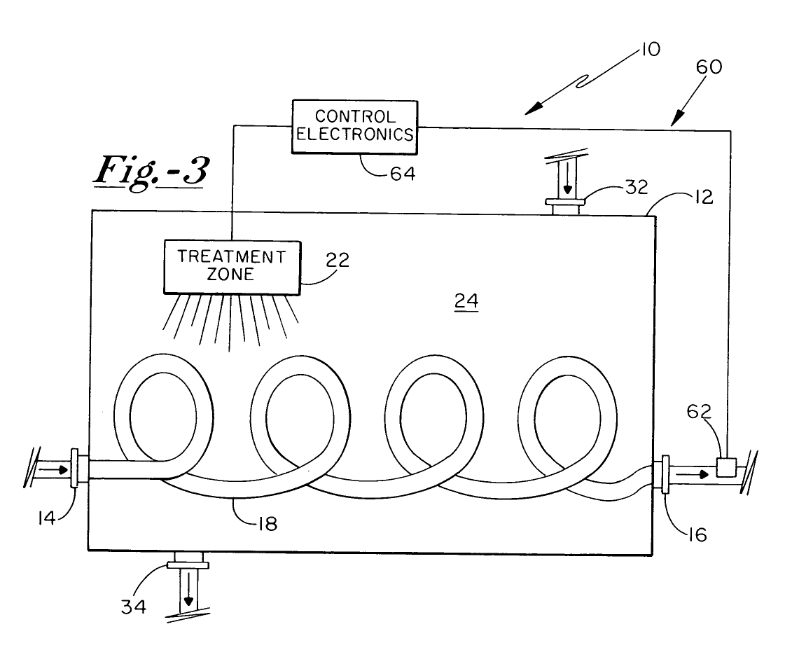

In some embodiments of the present invention, and as illustrated in FIG. 3, a feedback control loop 60 is provided for operably controlling various process variables such as the concentration, amount, and/or intensity of the organic matter treatment agents being released by dispensing device 22. In order to operably maintain a desired level of organic matter treatment, feedback control loop 60 includes a detector 62 positioned adjacent to outlet connection 16, which detector 62 operably senses an operating condition, such as the concentration of organic matter in the liquid stream exiting treatment chamber 12. Such organic matter concentration sensors are well known in the art, and can include IR absorbance, conductivity, ion selective electrodes, or gas sensing/measuring devices. An example sensor is available from InUSA under the trade name DFFOZ. Detector 62 is preferably configured to transmit electrical signals to the control electronics 64. Such signals are interpreted by control electronics 64 so as to dynamically adjust one or more process variables to thereby adjusting the level of organic matter treatment in the liquid stream. System 10 of the present invention may utilize one or more of such detectors 62 to analyze various operating conditions. For example, such detectors 62 may measure a target gas concentration within zone 24 of chamber 12 at sweep fluid outlet 34, or downstream from outlet 16 of chamber 12. Such detectors may measure absolute or relative concentrations of the target product gas at various locations of system 10.

While control electronics 64 is depicted in FIG. 3 as being operably coupled to dispensing device 22 for adjusting the rate of treatment agent release, it is contemplated by the present invention to control a variety of process variables based upon the information obtained by the one or more detectors 62. For example, the control electronics 64 may be programmed to operably control a vacuum set point within chamber 12, or alternatively the sweep fluid flow rate passing through zone 24 of chamber 12. A myriad of other process variables may be controlled through a feedback control scheme continuously or intermittently sampling conditions present at system 10.

In some embodiments of the present invention, a photocatalyst material such as titanium dioxide or bare zirconia is disposed in or on an internal surface of conveyance member 18 so that ultraviolet radiation being utilized as the organic matter treatment agent causes the photocatalyst material to create an oxidizing reagent. The photo catalyst material may also or instead be disposed within the channel defined by conveyance member 18 in the form of a rod, thread, or other structure accessible to the ultraviolet radiation, such that the oxidizing reagent generated upon exposure to ultraviolet radiation is released to the liquid stream.

Although FIGS. 1-3 illustrate dispensing device 22 as being disposed within treatment chamber 12, it is contemplated by the present invention that dispensing device 22 may be disposed external to chamber 12 in embodiments wherein ultraviolet radiation is being operably emitted from dispensing device 22. In such embodiments, therefore, treatment chamber 12 may be fabricated from a material that is transparent to ultraviolet radiation being emitted from dispensing device 22. An example material that may be useful in such an embodiment is quartz glass, through which ultraviolet radiation of designated wavelength may be directed at conveyance member 18.

The invention has been described herein in considerable detail in order to comply with the patent statutes, and to provide those skilled in the art with the information needed to apply the novel principles and to construct and use embodiments of the invention as required. However, it is to be understood that the invention can be carried out by specifically different devices and that various modifications can be accomplished without departing from the scope of the invention itself.

What is claimed is:

1. A method for treating organic matter in a liquid, the method comprising:
(a) transporting said liquid through a pathway defined by a containment member comprising a substantially gas-permeable, liquid-impermeable material;
(b) introducing said liquid to an organic matter treatment agent while said liquid is disposed in said pathway; and
(c) removing one or more product gases from said liquid through a wall of said containment member, said one or more product gases being disposed in the liquid as a consequence of the treatment of the organic matter by said treatment agent.

2. A method as in claim 1 wherein said containment member is substantially transparent to ultraviolet radiation.

3. A method as in claim 1 wherein said containment member is tubing.

4. A method as in claim 1 wherein said gas-permeable, liquid-impermeable material is a copolymer of perfluoro-2,2-dimethyl-1,3-dioxole.

5. A method as in claim 1 wherein said organic matter treatment agent is selected from the group consisting of ultraviolet radiation, H₂, H₂O₂, O₂, ClO₂, ozone, and combinations thereof.

6. A method as in claim 1 wherein the removal of said one or more product gases from said liquid is accomplished by passing a sweep fluid about said containment member.

7. A method as in claim 1 wherein said containment member includes a photo catalyst material disposed therewith.

8. A method as in claim 1, including monitoring an operating condition with a detector and transmitting signals generated by said detector to a feedback control means for dynamically adjusting a process variable.

9. A method as in claim 8 wherein said operating condition is selected from the group consisting of organic matter concentration, product gas concentration, and combinations thereof.

10. A method as in claim 8 wherein said process variable is selected from the group consisting of a dispensing rate of said organic matter treatment agent, a vacuum set point, a sweep fluid flow rate, sweep fluid composition, ultraviolet radiation intensity, and combinations thereof.

11. A method for treating organic matter in a liquid, the method comprising:
(a) providing a treatment chamber having a liquid conveyance member passing therethrough, said liquid conveyance member comprising a substantially gas-permeable, liquid-impermeable material;
(b) transporting said liquid in said liquid conveyance member and through said treatment chamber;
(c) introducing said liquid to an organic matter treatment agent while said liquid is disposed in said treatment chamber; and
(d) removing one or more product gases from said liquid through a wall of said conveyance member, said one or more product gases being disposed in the liquid as a consequence of the treatment of the organic matter by said treatment agent.

12. A method as in claim 11 wherein said treatment chamber is at least partially evacuated.

13. A method as in claim 12, including pumping gas out from said treatment chamber so as to maintain a reduced pressure environment within said treatment chamber.

14. A method as in claim 11 wherein said conveyance member is substantially transparent to ultraviolet radiation.

15. A method as in claim 11 wherein said conveyance member is tubing.

16. A method as in claim 11 wherein said gas-permeable, liquid-impermeable material is a copolymer of perfluoro-2,2-dimethyl-1,3-dioxole.

17. A method as in claim 11 wherein said organic matter treatment agent is selected from the group consisting of ultraviolet radiation, H₂, H₂O₂, O₂, ClO₂, ozone, and combinations thereof.

18. A method as in claim 11 wherein respective first partial pressures of said one or more product gases in said first fluid are higher than corresponding ones of respective second partial pressures of said one or more product gases external to said conveyance member and within said treatment chamber.

19. A system for treating organic matter in a liquid, the system comprising:
(a) a chamber;
(b) inlet and outlet connections for admitting and discharging the liquid to be treated.
(c) a conveyance member for conducting the liquid through said chamber between said inlet and outlet connections, said conveyance member being formed of a gas-permeable, liquid-impermeable material; and
(d) an organic matter treatment agent dispensing device arranged for introducing the liquid to one or more organic matter treatment agents while disposed in said chamber, such that one or more product gases are developed in the liquid to respective first partial pressures as a result of the treatment of the organic matter by said one or more organic matter treatment agents, said chamber having respective second partial pressures of said one or more product gases that are lower than corresponding first partial pressures of such product gases, so as to remove the one or more product gases from said liquid through an outer wall of said conveyance member.

20. A system as in claim 19 wherein said chamber is a vacuum chamber that is adapted to be connected to a source for creating a vacuum in said chamber.
